(19) United States
(12) Patent Application Publication
(10) Pub. No.: US 2021/0341646 A1
(43) Pub. Date: Nov. 4, 2021

(54) WEATHER PARAMETER PREDICTION MODEL TRAINING METHOD, WEATHER PARAMETER PREDICTION METHOD, ELECTRONIC DEVICE AND STORAGE MEDIUM

(71) Applicant: Beijing Baidu Netcom Science and Technology Co., Ltd., Beijing (CN)

(72) Inventors: Hao Liu, Beijing (CN); Jindong Han, Beijing (CN); Hengshu Zhu, Beijing (CN); Dejing Dou, Beijing (CN)

(21) Appl. No.: 17/373,113

(22) Filed: Jul. 12, 2021

(30) Foreign Application Priority Data
Dec. 23, 2020 (CN) 202011541723.4

(51) Int. Cl. G01W 1/10; G06N 3/04; G06N 3/08; G06F 17/17

(52) U.S. Cl. CPC G01W 1/10; G06N 3/049; G01W 2001/006; G06F 17/17; G06N 3/08

(57) ABSTRACT

A weather parameter prediction model training method, a weather parameter prediction method, an electronic device and a storage medium are provided, and relate to the technical field of artificial intelligence, such as deep learning and big data. The method includes: establishing a weather parameter prediction model according to spatial correlation information among a plurality of monitoring stations; and adjusting the weather parameter prediction model according to observation values of a weather parameter for the plurality of monitoring stations and prediction values of the weather parameter for the plurality of monitoring stations output by the weather parameter prediction model. The present disclosure can improve an accuracy of predicting weather parameters.

### CROSS-REFERENCE TO RELATED APPLICATION

This application claims priority to Chinese Patent Application No. 202011541723.4, filed on Dec. 23, 2020, which is hereby incorporated by reference in its entirety.

### TECHNICAL FIELD

The present disclosure relates to the technical field of computer, in particular to the technical field of artificial intelligence such as deep learning and big data.

### BACKGROUND

With development of economy and technology as well as improvement of people's living conditions, people are paying more and more attention to life and health, and have higher quality and safety requirements for living environment.

Due to rapid improvement of industrialization level, air quality has become one of factors closely related to people's life and health issues. Then, demands for weather parameter prediction is gradually increasing in fields of weather forecasting and travel. Sufficiently accurate prediction data is one of primary needs of people for weather parameter prediction and weather forecasting.

### SUMMARY

The present disclosure provides a weather parameter prediction model training method, a weather parameter prediction method, apparatus and device, and a storage medium.

In one aspect, the present disclosure provides a weather parameter prediction model training method, including:

establishing a weather parameter prediction model according to spatial correlation information among a plurality of monitoring stations; and

adjusting the weather parameter prediction model according to observation values of a weather parameter for the plurality of monitoring stations and prediction values of the weather parameter output by the weather parameter prediction model for the plurality of monitoring stations.

In another aspect, the present disclosure provides a weather parameter prediction method, including:

taking at least one of historical observation values and environmental context features of a plurality of monitoring stations as input data, and inputting the input data into a weather parameter prediction model; wherein the weather parameter prediction model is the weather parameter prediction model of any one of claims 1 to 12;

using the weather parameter prediction model to determine spatial correlation information among the plurality of monitoring stations, according to the at least one of the historical observation values and the environmental context features of the plurality of monitoring stations obtained from the input data;

using the weather parameter prediction model to output a weather parameter prediction value according to the spatial correlation information among the plurality of monitoring stations.

In another aspect, the present disclosure provides a weather parameter prediction model training apparatus, including:

an establishment module configured for establishing a weather parameter prediction model according to spatial correlation information among a plurality of monitoring stations; and

an adjustment module configured for adjusting the weather parameter prediction model according to observation values of a weather parameter for the plurality of monitoring stations and prediction values of the weather parameter output by the weather parameter prediction model for the plurality of monitoring stations.

In another aspect, the present disclosure provides a weather parameter prediction apparatus, including:

an input module configured for taking at least one of historical observation values and environmental context features of a plurality of monitoring stations as input data, and inputting the input data into a weather parameter prediction model; wherein the weather parameter prediction model is the weather parameter prediction model of any one of embodiments of the present disclosure;

a spatial correlation module configured for using the weather parameter prediction model to determine spatial correlation information among the plurality of monitoring stations, according to the at least one of the historical observation values and the environmental context features of the plurality of monitoring stations obtained from the input data; and

a prediction module configured for using the weather parameter prediction model to output a weather parameter prediction value according to the spatial correlation information among the plurality of monitoring stations.

In another aspect, the present disclosure provides an electronic device, including:

at least one processor; and

a memory communicatively connected to the at least one processor; wherein,

the memory stores instructions executable by the at least one processor to enable the at least one processor to implement the method of any one of embodiments of the present disclosure.

In another aspect, the present disclosure provides a non-transitory computer-readable storage medium storing computer instructions. The computer instructions are configured for causing the computer to perform the method of any one of embodiments of the present disclosure.

In another aspect, the present disclosure provides a computer program product including a computer program for causing a processor to perform the method of any one of embodiments of the present disclosure.

It is to be understood that the contents in this section are not intended to identify the key or critical features of the embodiments of the present disclosure, and are not intended to limit the scope of the present disclosure. Other features of the present disclosure will become readily apparent from the following description.

### BRIEF DESCRIPTION OF THE DRAWINGS

The drawings are included to provide a better understanding of the disclosure and are not to be construed as limiting the disclosure. Wherein:

FIG. 1 is a flowchart of a weather parameter prediction model training method according to an embodiment of the present disclosure;

FIG. 2 is a flowchart of a weather parameter prediction method according to another embodiment of the present disclosure;

FIG. 3A is a schematic diagram of monitoring stations according to an example of the present disclosure;

FIG. 3B is a schematic diagram of observation data of an air quality monitoring station according to an example of the present disclosure;

FIG. 3C is a schematic diagram of observation data of a weather monitoring station according to an example of the present disclosure;

FIG. 4 is a schematic diagram of a model structure according to an example of the present disclosure;

FIG. 5 is a flowchart of a weather parameter prediction model training method according to an embodiment of the present disclosure;

FIG. 6 is a schematic diagram of a weather parameter prediction model training apparatus according to an embodiment of the present disclosure;

FIG. 7 is a schematic diagram of a weather parameter prediction model training apparatus according to another embodiment of the present disclosure;

FIG. 8 is a schematic diagram of a weather parameter prediction model training apparatus according to still another embodiment of the present disclosure;

FIG. 9 is a schematic diagram of a weather parameter prediction model training apparatus according to still another embodiment of the present disclosure;

FIG. 10 is a schematic diagram of a weather parameter prediction model training apparatus according to still another embodiment of the present disclosure;

FIG. 11 is a schematic diagram of a weather parameter prediction model training apparatus according to still another embodiment of the present disclosure;

FIG. 12 is a schematic diagram of a weather parameter prediction model training apparatus according to still another embodiment of the present disclosure; and

FIG. 13 is a block diagram of an electronic device for implementing a weather parameter prediction model training method according to an embodiment of the present disclosure.

### DETAILED DESCRIPTION

Reference will now be made in detail to the exemplary embodiments of the present disclosure, examples of which are illustrated in the accompanying drawings, wherein the various details of the embodiments of the present disclosure are included to facilitate understanding and are to be considered as exemplary only. Accordingly, a person skilled in the art should appreciate that various changes and modifications can be made to the embodiments described herein without departing from the scope and spirit of the present disclosure. Also, descriptions of well-known functions and structures are omitted from the following description for clarity and conciseness.

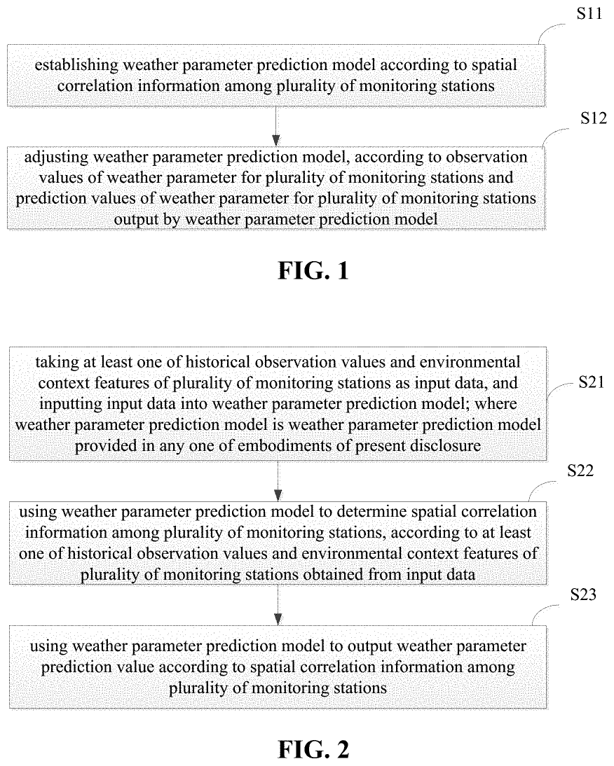

As shown in FIG. 1, one embodiment of the present disclosure provides a weather parameter prediction model training method, including:

Step S11: establishing a weather parameter prediction model according to spatial correlation information among a plurality of monitoring stations;

Step S12: adjusting the weather parameter prediction model according to observation values of a weather parameter for the plurality of monitoring stations and prediction values of a weather parameter output by the weather parameter prediction model for the plurality of monitoring stations.

The monitoring stations may include monitoring stations for monitoring different weather parameters. For example, the monitoring stations may include a wind speed monitoring station, an air quality index (AQI) monitoring station, a weather forecast monitoring station, and so on.

In this embodiment, the weather parameter may be any forecast parameter in the weather forecast, or may be an air quality parameter.

The parameter involved in the weather forecast may be at least one of temperature, humidity, pressure, wind speed, wind direction and other parameters.

The monitoring stations may include only monitoring stations for monitoring an identical weather parameter, or may include monitoring stations for monitoring different weather parameters.

The plurality of monitoring stations may be used to monitor an identical weather parameter, or may be used to monitor different weather parameters.

The spatial correlation information among the plurality of monitoring stations may include spatial correlation information of every two monitoring stations in the plurality of monitoring stations. The spatial correlation information among the plurality of monitoring stations may include spatial correlation information of the plurality of monitoring stations of each category obtained by clustering the plurality of monitoring stations.

For example, according to geographic distance, the plurality of monitoring stations may be divided into a first monitoring station set, a second monitoring site station and a third monitoring station set. Then, one way for determining the spatial correlation information among the plurality of monitoring stations includes: for the three sets, calculating spatial correlation information among the monitoring stations in each set respectively; and, combining the spatial correlation information among the monitoring stations in each of the three sets into the spatial correlation information among the plurality of monitoring stations.

The adjusting the weather parameter prediction model according to the observation values of the weather parameter for the plurality of monitoring stations and the prediction values of the weather parameter output by the weather parameter prediction model for the plurality of monitoring stations, may include adjusting the weather parameter prediction model in a stage of training the model after establishment of the model; or, may include further adjusting and optimizing the weather parameter prediction model through data generated in actual use after the model training is completed and the model is deployed.

The spatial correlation information among the plurality of monitoring stations may further include temporal correlation information among the plurality of monitoring stations. The temporal correlation information among the plurality of monitoring stations may be obtained by calculating correlation information between historical time and current time for each monitoring station and then aggregating calculation results of the plurality of monitoring stations.

In the embodiments of the present disclosure, the weather parameter prediction model is established according to the spatial correlation information among the plurality of monitoring stations, thus, the model can predict weather parameters according to the spatial correlation information among the plurality of monitoring stations, thereby improving accuracy of the weather parameter prediction model for predicting the weather parameters.

In one embodiment, the plurality of monitoring stations include monitoring stations of the plurality of categories. The monitoring stations of each category are used to monitor a weather parameter of a corresponding category. For example, some monitoring stations are used to monitor a weather parameter of a category A, another monitoring stations are used to monitor a weather parameter of a category B, and the category A and the category B are different categories. Each of the category A and the category B may include a plurality of categories. In a case that each of the category A and the category B includes a plurality of categories, the category A and the category B may be partially the same, for example, the category A includes categories a1, a2 and b1, the category B includes categories b2 and b1.

The spatial correlation information among the plurality of monitoring stations includes spatial correlation information of monitoring stations of the plurality of categories.

In this embodiment, the monitoring stations of each category may be used to monitor an identical weather parameter.

The spatial correlation information of monitoring stations of the plurality of categories may include spatial correlation information of different monitoring stations of the same category, or may include spatial correlation information of different monitoring stations of different categories.

In the embodiments of the present disclosure, the spatial correlation information may mainly refer to information related to distances, and may include a horizontal distance or a vertical distance from a horizontal plane.

The spatial correlation information may also include spatial correlation information generated by geographic environment and geographic location. For example, two closely spaced monitoring stations in the same air passage, may have greater spatial correlation with each other.

For another example, spatial correlation between two monitoring stations close to each other in an area with a high wind speed may be greater than spatial correlation between two monitoring stations close to each other in an area with a low wind speed.

For another example, for two monitoring stations close to each other, spatial correlation between the two may be affected due to one of the two being close to the ocean and other special geographic environment.

The weather parameter prediction model is established according to the spatial correlation information of monitoring stations of the plurality of categories, thus an establishment process of the weather parameter prediction model can take advantage of mutual influence between different weather parameters, such as influence of wind speed and wind direction to weather parameters such as air quality, temperature and humidity, thereby improving the accuracy of weather parameter prediction.

In one embodiment, the spatial correlation information of monitoring stations of the plurality of categories is determined according to spatial correlation information between each monitoring station and other monitoring station.

Each monitoring station and other monitoring station may include each monitoring station itself and its neighboring monitoring station. For example, there are 3 monitoring stations in total; for the 3 monitoring stations, each monitoring station has a neighboring monitoring station.

The neighbor monitoring station of each monitoring station may be determined according to distances between the monitoring stations. For example, the monitoring stations with a distance of less than 10 km, 20 km, or 30 km, may be monitoring stations with neighbor relationship.

For example, distances between monitoring stations A, B, and C may be that the a distance between the monitoring stations A and B is less than a set distance threshold, a distance between the monitoring stations A and C is greater than the set distance threshold, and a distance between monitoring stations B and C is less than the set distance threshold. Then, the neighbor monitoring station of the monitoring station A is the monitoring station B; the neighbor monitoring stations of the monitoring station B are the monitoring stations C and A; and the neighbor monitoring station of the monitoring station C is the monitoring station B.

Considering that weather parameters in closer areas have a higher degree of influence, in this embodiment, the spatial correlation information of monitoring stations of the plurality of categories includes spatial correlation information of monitoring stations with neighboring relationship, which can appropriately reduce an amount of calculation while fully considering influence between the monitoring stations, thereby improving a prediction efficiency and an accuracy of the prediction results.

In one embodiment, the spatial correlation information among the plurality of monitoring stations includes spatial correlation information between each monitoring station and other monitoring station.

The spatial correlation information between each monitoring station and other monitoring station is determined according to a dynamic connection line weight between each monitoring station and other monitoring station, observation data of each monitoring station and other monitoring station and categories of each monitoring station and other monitoring station.

In this embodiment, the other monitoring station may be a neighboring monitoring station. A dynamic connection line between each monitoring station and its neighboring monitoring station may be a connection line formed by connecting each monitoring station with its neighbor monitoring station.

The dynamic connection line weight between each monitoring station and its neighboring monitoring station may be a weight of a dynamic connection line between each monitoring station and its neighboring monitoring station. The dynamic connection line between each monitoring station and its neighboring monitoring station is a directed connection line. For example, a connection line from a monitoring station A and to a monitoring station B may be different from a connection line from the monitoring station B and to the monitoring station A.

The observation data of each monitoring station may be monitoring data of weather parameters that each monitoring station is responsible for monitoring.

The categories of each monitoring station and its neighboring monitoring station may include the category of each monitoring station and the category of the neighboring monitoring station of each monitoring station.

For example, there are neighboring monitoring stations B, C, and D for a monitoring station A. Then, spatial correlation information of the monitoring station A and its neighboring monitoring stations, includes: spatial correlation information between the monitoring station A and the monitoring station B, spatial correlation information between the monitoring station A and the monitoring station C, and spatial correlation information between the monitoring station A and the monitoring station D.

Further, the spatial correlation information between the monitoring station A and the monitoring station B is determined according to a dynamic connection line weight between the monitoring stations A and B, observation data of the monitoring stations A and B and categories of the monitoring stations A and B.

The spatial correlation information between the monitoring station A and the monitoring station C is determined according to a dynamic connection line weight between the monitoring station A and the monitoring station C, observation data of the monitoring stations A and C and categories of the monitoring stations A and C.

The spatial correlation information between the monitoring station A and the monitoring station D is determined according to a dynamic connection line weight between the monitoring stations A and D, observation data of the monitoring stations A and D and categories of the monitoring stations A and D.

In this embodiment, by determining the spatial correlation information of each monitoring station and its neighboring monitoring station (i.e., other monitoring station), correlation between the monitoring stations can be obtained. Meanwhile, redundant calculations can be avoided, thereby improving a prediction efficiency and a prediction accuracy of the weather parameters.

In one embodiment, the dynamic connection line weight between each monitoring station and other monitoring station is determined according to a spherical distance between each monitoring station and other monitoring station, and environmental context features of each monitoring station and other monitoring station.

The spherical distance between each monitoring station and its neighboring monitoring station may be a spherical distance on the earth's surface between each monitoring station and its neighboring monitoring station.

The environmental context features of each monitoring station and its neighboring monitoring station may include environmental context features of the each monitoring station and environmental context features of the neighboring monitoring station of the each monitoring station.

Specifically, for example, neighboring monitoring stations of a monitoring station A include monitoring stations B and C. Then, a dynamic connection line weight between the monitoring station A and the neighboring monitoring station B is determined according to a spherical distance between the monitoring stations A and B, environmental context features of the monitoring station A, and environmental context features of the monitoring station B.

Further, a dynamic connection line weight between the monitoring station A and the neighboring monitoring station C is determined according to a spherical distance between the monitoring stations A and C, environmental context features of the monitoring station A, and environmental context features of the monitoring station C.

In this embodiment, the distance between the each monitoring station and its neighboring monitoring station and environmental context feature information of the each monitoring station and its neighboring monitoring station are combined to determine the correlation information of each monitoring station and its neighboring monitoring station, so that prediction of weather parameters can simultaneously consider the spatial correlation between the monitoring stations and environmental information of the monitoring stations, thereby making prediction results more accurate.

In one embodiment, one way for determining the spatial correlation information between each monitoring station and other monitoring station includes:

projecting observation data of each monitoring station and other monitoring station into an identical representation space to obtain projection values of each monitoring station and other monitoring station;

determining spatial correlation information of monitoring stations of the plurality of categories, according to the projection values of each monitoring station and other monitoring station.

In this embodiment, monitoring stations of different categories obtain different weather parameters. For example, a weather parameter monitored by a wind speed monitoring station is wind speed, and a weather parameter monitored by an air quality monitoring station is air quality. Therefore, projecting the observation data of each monitoring station and its neighboring monitoring station into the identical representation space, can facilitate subsequent unified calculations, while retaining observation data information of each monitoring station.

In one embodiment, the spatial correlation information between each monitoring station and other monitoring station is determined according to spatial correlation information among each monitoring station and its all other monitoring stations.

For example, in an example, neighboring monitoring stations of a monitoring station A include monitoring stations B and C, then, correlation information between the monitoring station A and its neighboring monitoring stations is determined according to correlation information between the monitoring station A and the monitoring station B, and correlation information between the monitoring station A and the monitoring station C.

Meanwhile, in calculation process, each monitoring station is used as a reference to calculate the correlation information between the each monitoring station and its neighboring monitoring station.

For example, in another example, monitoring stations include monitoring stations A, B, and C in total. Neighboring monitoring stations of the monitoring station A are the monitoring stations B and C. A neighboring monitoring station of the monitoring station B is the monitoring station A. A neighboring monitoring station of the monitoring station C is the monitoring station A. Then, it is necessary to calculate correlation information between the monitoring station A and its neighboring monitoring stations, correlation information between the monitoring station B and its neighbor monitoring station, and correlation information between the monitoring station C and its neighbor monitoring station. The correlation information between the monitoring station A and its neighboring monitoring stations includes: correlation information between the monitoring station A and the monitoring station B, and correlation information between the monitoring station A and the monitoring station C. The correlation information between the monitoring station B and its neighbor monitoring station includes correlation information between the monitoring station B and the monitoring station A. The correlation information between the monitoring station C and its neighbor monitoring station includes correlation information between the monitoring station C and the monitoring station A.

Still referring to the foregoing example, when calculating the correlation information between the monitoring stations A and B and the correlation information between the monitoring stations B and A, a dynamic connection line weight between the monitoring stations A and B, and a dynamic connection weight between the monitoring stations B and A, are corresponding to directed edges that overlap and direct in different directions, namely a directed edge A-B and a directed edge B-A.

In this embodiment, the correlation information between each monitoring station and its neighboring monitoring station is determined according to the correlation information between each monitoring station and all its neighboring monitoring stations, thereby fully grasping neighboring relationship between the stations and then making the prediction results more accurate.

In one implementation, the correlation information between each monitoring station and other monitoring station is determined according to a projection value of other monitoring station, a dynamic connection line weight between each monitoring station and other monitoring station, a category of each monitoring station and a category of every other monitoring station.

When determining the correlation information between each monitoring station and its neighboring monitoring station, the correlation between each monitoring station and its neighboring monitoring stations can be fully considered, thereby making the prediction results of weather parameters more accurate.

In one embodiment, one way of calculating the correlation information between each monitoring station and other monitoring station includes:

for every other monitoring station, multiplying a dynamic connection line weight between every other monitoring station and each monitoring station, a dynamic connection line type between every other monitoring station and each monitoring station, and a projection value of every other monitoring station, to obtain a first characteristic value of every other monitoring station;

for every other monitoring station, performing calculation on the first characteristic value of every other monitoring station by using nonlinear activation function to obtain a second characteristic value of every other monitoring station;

for each monitoring station, splicing the second characteristic values of all other monitoring stations to obtain the spatial correlation information among each monitoring station and other monitoring stations.

In this embodiment, the foregoing parameters are parameters for neighboring monitoring stations participating in the calculation. For example, neighboring monitoring stations of a monitoring station A include neighboring monitoring stations B and C. Then, for the monitoring station A, a dynamic connection line weight between the monitoring stations A and B, a dynamic connection line type between the monitoring stations A and B, and a projection value of the monitoring station B are multiplied, and then a first characteristic value of the monitoring station B is obtained according to a multiplication result. Calculation is performed on the first characteristic value of the monitoring station B by using a nonlinear activation function, thereby obtaining a second characteristic value of the monitoring station B.

Subsequently, the same calculation process is performed on the monitoring station C, thereby obtaining the second characteristic values of all neighboring monitoring stations of the monitoring station A.

In this embodiment, through the foregoing calculations, an accuracy of weather parameter prediction results can be improved, so that the weather parameter prediction model has a higher comprehensive prediction ability.

In one embodiment, the monitoring stations of the plurality of categories include a monitoring station for monitoring a weather parameter of a first category and a monitoring station for monitoring a weather parameter of a second category.

In this embodiment, the weather parameter of the first category may be a parameter related to weather forecasting, for example, at least one of weather data such as temperature, humidity, wind speed, wind direction, and air pressure. The weather parameter of the first category may be corresponding to a weather monitoring station for weather forecasting. The weather parameter of the second category may be air quality parameters, and may be corresponding to an air quality monitoring station dedicated for monitoring air quality.

As the categories of weather parameters increase, the categories of monitoring stations are gradually increasing. Observation results of monitoring stations of different categories are integrated to predict weather parameters, which can improve the accuracy of the prediction.

In one embodiment, establishing a weather parameter prediction model according to spatial correlation information among the plurality of monitoring stations, includes:

determining temporal-and-spatial correlation information among the plurality of monitoring stations according to the spatial correlation information among the plurality of monitoring stations and historical temporal-and-spatial correlation information among the plurality of monitoring stations;

establishing the weather parameter prediction model according to the temporal-and-spatial correlation information among the plurality of monitoring stations.

The historical temporal-and-spatial correlation information of the monitoring station is historical temporal-and-spatial correlation information at one or more historical moments before the current moment, and may be generated when the weather parameter prediction model is used to predict the weather parameters at a previous moment.

The historical temporal-and-spatial correlation information may include temporal correlation information at multiple historical moments and spatial correlation information of the monitoring station. The temporal correlation information at multiple historical moments of the monitoring station, may be correlation information of each monitoring station's own observation value at a historical moment and a current moment. The temporal correlation information at multiple historical moments of the monitoring station, may also be correlation information between observation values of the plurality of monitoring stations at a historical moment and a current moment.

When establishing the weather parameter prediction model, the spatial correlation information and temporal correlation information among the plurality of monitoring stations are considered simultaneously, thereby improving the prediction accuracy of the prediction model.

In one embodiment, determining temporal-and-spatial correlation information among the plurality of monitoring stations according to the spatial correlation information among the plurality of monitoring stations and historical temporal-and-spatial correlation information among the plurality of monitoring stations, includes:

performing a gate recurrent operation on the spatial correlation information among the plurality of monitoring station and the historical temporal-and-spatial correlation information among the monitoring stations to obtain the temporal-and-spatial correlation information among the plurality of monitoring stations.

In this embodiment, the gate recurrent operation may be performed by a gated recurrent unit (GRU).

By performing the gate recurrent operation with the gated recurrent unit, temporal-and-spatial correlation information among the plurality of monitoring stations at a first moment can be determined according to spatial correlation information among the plurality of monitoring stations at the first moment and temporal-and-spatial correlation information among the monitoring stations at a historical moment before the first moment.

By performing the gate recurrent operation with the gated recurrent unit, temporal-and-spatial correlation information among the plurality of monitoring stations at a second moment can be determined according to spatial correlation information among the plurality of monitoring stations at the second moment and temporal-and-spatial correlation information among the monitoring stations at a historical moment before the second moment. The second moment is the next moment of the first moment, and the historical moment before the second moment includes the first moment.

Through the gate recurrent operation, for multiple historical moments, influence of a previous historical moment on a subsequent historical moment can be gradually calculated, thereby improving an accuracy of calculation of the temporal-and-spatial correlation information and further improving an accurate prediction ability of the weather parameter prediction model.

In one embodiment, adjusting the weather parameter prediction model according to observation values of a weather parameter for the plurality of monitoring stations and prediction values of the weather parameter for the plurality of monitoring stations output by the weather parameter prediction model, includes:

calculating a loss value according to a least square error of the observation values and the prediction values;

adjusting the weather parameter prediction model according to the loss value.

The observation value and the prediction value may be an observation value and a prediction value of a weather parameter of the same category, for example, they are an observation value and a prediction value of temperature.

In this embodiment, the model is adjusted and optimized by using the least square error of the observation value and the prediction value, so that the prediction result of the model can be more accurate after adjustment, thereby improving prediction function of the model.

As shown in FIG. 2, one embodiment of the present disclosure further provides a weather parameter prediction method, including:

Step S21: taking at least one of historical observation values and environmental context features of a plurality of monitoring stations as input data, and inputting the input data into a weather parameter prediction model; where the weather parameter prediction model is the weather parameter prediction model provided in any one of the embodiments of the present disclosure;

Step S22: using the weather parameter prediction model to determine spatial correlation information among the plurality of monitoring stations, according to at least one of the historical observation values and environmental context features of the plurality of monitoring stations obtained from the input data;

Step S23: using the weather parameter prediction model to output a weather parameter prediction value according to the spatial correlation information among the plurality of monitoring stations.

In this embodiment, which category of weather parameter needs to be predicted, and historical observation values of which category of weather parameter can be used as input. The historical observation values may be observation values at multiple historical moments.

Taking at least one of historical observation values and environmental context features of the plurality of monitoring stations as input data, means that historical observation values of a weather parameter at the plurality of monitoring stations may be used as input data, or an environmental context feature of the plurality of monitoring stations may be used as input data.

The environmental context feature may be obtained from environmental information, such as one or more of environmental conditions such as greening conditions, industrial zone conditions, and road conditions.

In this embodiment of the present disclosure, the weather parameter prediction model is used to predict the weather parameters. The weather parameter prediction model is a model obtained by the weather parameter prediction model training method provided in any one of the embodiments of the present disclosure. Therefore, when predicting, the model can take into account the spatial correlation information among the plurality of monitoring stations to predict weather parameters, and thus has high prediction accuracy.

In one embodiment, using the weather parameter prediction model to output a weather parameter prediction value according to the spatial correlation information among the plurality of monitoring stations, includes:

using the weather parameter prediction model to determine temporal-and-spatial correlation information among the plurality of monitoring stations according to the spatial correlation information among the plurality of monitoring stations;

using the weather parameter prediction model to determine the weather parameter prediction value of the plurality of monitoring stations according to the temporal-and-spatial correlation information among the plurality of monitoring stations.

In this embodiment, when predicting, the spatial correlation information among the plurality of monitoring stations is combined to determine the temporal-and-spatial correlation information among the plurality of monitoring stations, and then the prediction is made according to the temporal-and-spatial correlation information. In this way, the prediction result takes into account the spatial correlation and temporal correlation at different moments of the plurality of monitoring stations, and thus is more accurate.

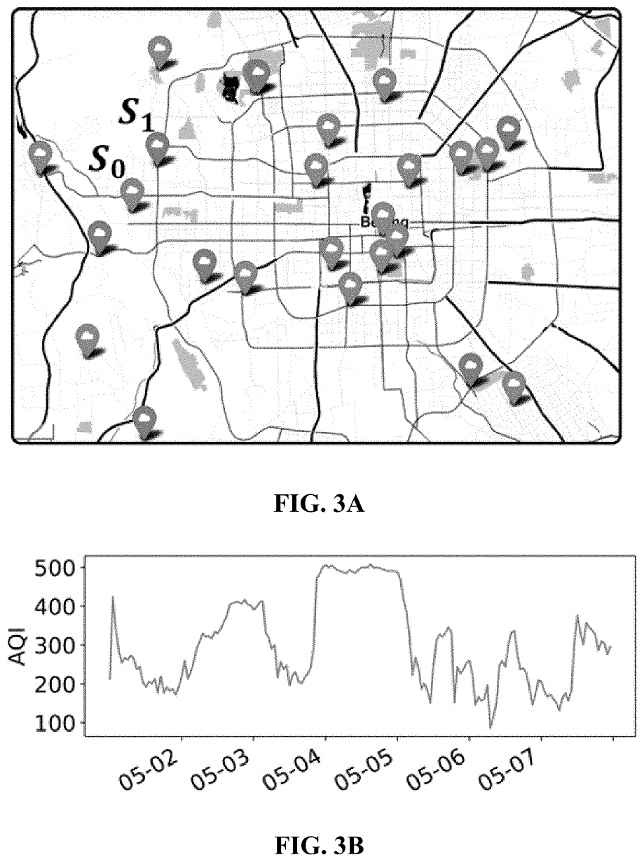

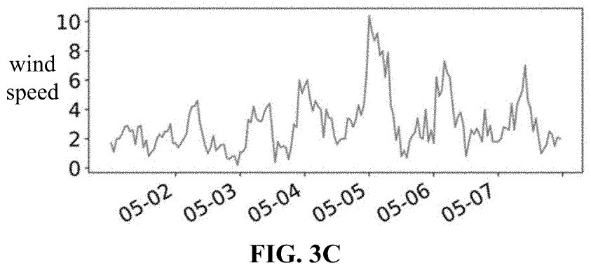

In an example of the present disclosure, distribution of monitoring stations in a certain area is shown in FIG. 3A, where S₀ and S₁ represent monitoring stations of two categories, respectively. In the area shown in FIG. 3A, the monitoring stations of two categories monitor in real time air quality and weather conditions at different position in the city. Stations of different categories distributed in the geographic space shown in FIG. 3A are heterogeneous, and they monitor different real-time atmospheric information respectively.

FIG. 3B shows a case where observation values obtained by an air quality monitoring station S₀ shown in FIG. 3A changes over time. FIG. 3C shows a case where observation values obtained by a weather monitoring station S₁ shown in FIG. 3A changes over time.

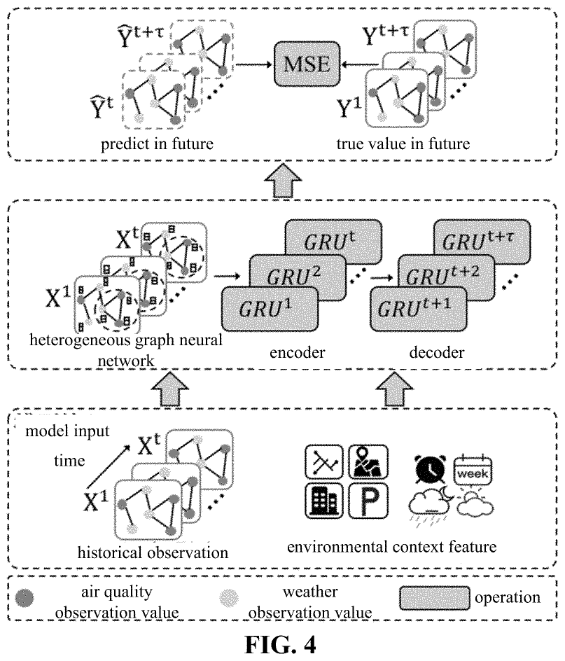

In this example, a heterogeneous graph neural network is proposed to model spatial dynamic correlation between stations of different categories, according to real-time observation values of the monitoring stations and surrounding environment context features (such as distribution of surrounding POIs and road network features). Heterogeneous gated recurrent neural network (GRU) is used as an encoder to capture temporal correlation of the stations, thereby obtaining a representation vector containing temporal-and-spatial correlation of the stations at the same time. Finally, a decoder (GRU) is used to predict air quality or weather conditions of all stations in the future. An overall framework of the weather parameter prediction model is shown in FIG. 4.

The input data of the weather parameter prediction model includes a historical observation value, a moment corresponding to the historical observation value, and environmental context features. In a prediction phase, data processing and weather parameter prediction are performed through the heterogeneous graph neural network, the GRU encoder and the GRU decoder. In a model adjustment stage, a loss value is calculated through Mean Square Error (MSE) loss function, and the weather parameter prediction model is predicted.

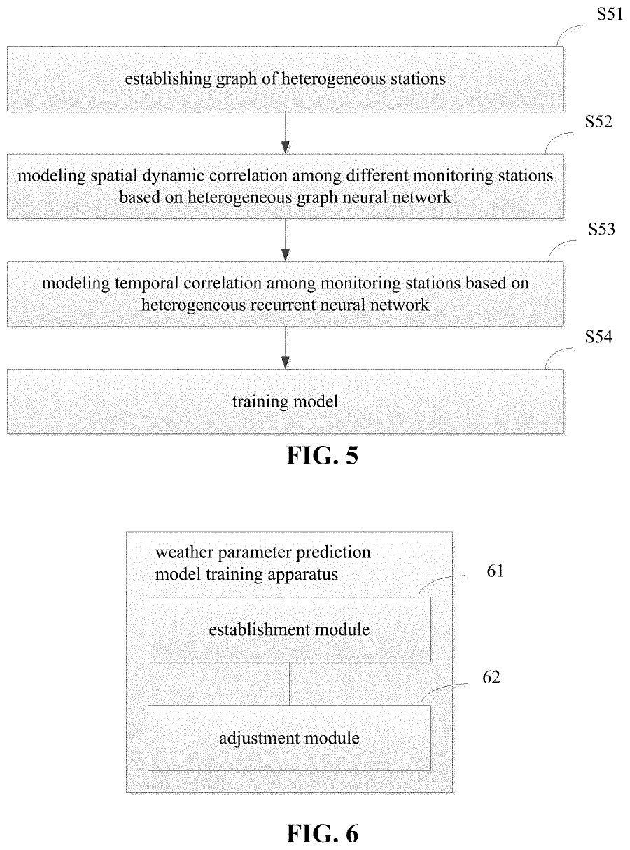

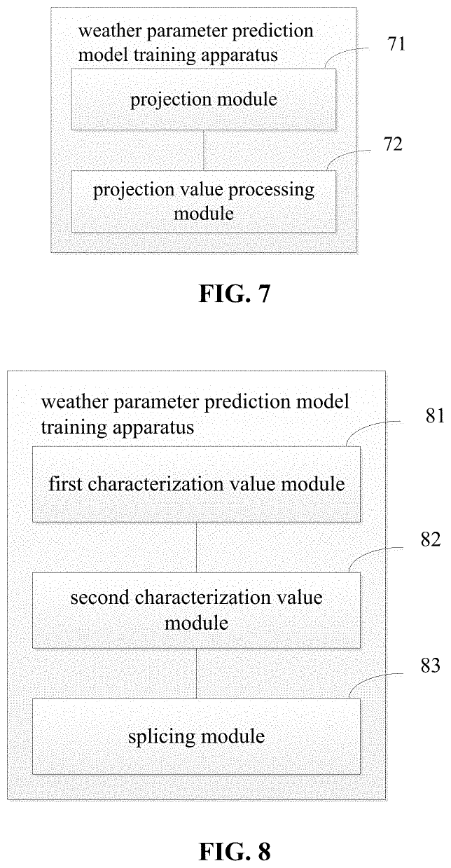

In an example of the present disclosure, the weather parameter prediction model training method includes the following steps shown in FIG. 5.

Step S51: establishing a graph of heterogeneous stations.

In this example, the heterogeneous stations may be monitoring stations for monitoring different weather parameters, or may be monitoring stations with obvious differences in scopes of monitoring data. The heterogeneous stations may refer to monitoring stations of different categories described in other embodiments of the present disclosure.

In this example, observation values of neighboring monitoring stations in geographic space are highly correlated and affect each other, and this correlation changes dynamically with time. For example, distribution of POI in a certain area is sparse, a density is relatively small, and a wind speed is relatively high. Then, an air quality and weather monitoring stations in this area will have a stronger correlation. In a case that this heterogeneous spatial dynamic correlation between monitoring stations can be modeled, the air quality and weather can be better predicted jointly.

Therefore, in this example, a graph G (directed graph) of heterogeneous stations is established to associate the monitoring stations that may be geographically adjacent to each other. The graph of heterogeneous stations includes nodes and edges. The nodes may be various monitoring stations distributed in space. One node represents one monitoring station. The edge may be a connection line between stations. Further, the connection line between monitoring stations may be a directed connection line.

In this example, it is assumed that there is a strong correlation between stations that are close to each other. Thus, as an example, nodes corresponding to any two monitoring stations with a distance of less than 20 km, are connected with a line, thereby forming an edge. For two monitoring stations that can be connected with a line, they are each other's neighbor monitoring station, namely:

$${e}_{i j} = \{ \begin{matrix}1 , & dist ( {v}_{i} , {v}_{j} ) \leq 20 km \\ 0 , & other case\end{matrix} \qquad formula ( 1 )$$

Where dist(vᵢ, vⱼ) represents a spherical distance between monitoring stations sᵢ and sⱼ. s^{a} and s^{w} represent an air quality monitoring station and a weather monitoring station, respectively. Because of heterogeneity of monitoring stations, there are nodes of two different types in the graph of heterogeneous stations, which represent monitoring stations of two different categories. Since the edge between monitoring stations is a directed edge, the graph of heterogeneous stations may include four different types of edges Ψ={s^{a}−s^{a}, s^{a}−s_{w}, s_{w}−s^{w}, s^{w}−s^{a}}. In this example, φ(i) represents a category of a monitoring station sᵢ, φ(i)∈{air quality monitoring station, weather monitoring station}.

Step S52: modeling spatial dynamic correlation among different monitoring stations based on a heterogeneous graph neural network.

Based on the foregoing graph G of heterogeneous stations, this example proposes a heterogeneous graph neural network for detecting spatial interaction, i.e., spatial correlation information, between monitoring stations. Since spatial correlation between monitoring stations changes dynamically with time, at different moments, for different weather, spatial correlation between monitoring stations changes with the change of weather, and therefore also changes with time. Furthermore, weights of edges between different monitoring stations also change dynamically with time.

In this example, based on current observation values of various monitoring stations and environmental context features, an attention mechanism is used to capture in real time relationship between monitoring stations at different moments.

Given an observation value xᵢ of the station sᵢ at a certain moment, this example first designs a conversion layer based on categories of the stations, and projects heterogeneous observation data (observation values of monitoring stations of different categories) into a unified representation space \tilde{x}ᵢ=W^{φ(i)}xᵢ, where \tilde{x}_{ι} is a low-dimensional representation vector, and W^{φ(i)} is a learnable parameter matrix shared between stations of a category φ(i).

Then, this example introduces an attention mechanism related to types of edges to quantify spatially complex nonlinear correlation between homogeneous and heterogeneous stations in different environments. Given monitoring stations sᵢ, sⱼ, a type of an edge connecting the monitoring station sⱼ to the monitoring station sᵢ is r∈W, and a dynamic edge weight αᵢⱼ^{r} between the two stations is:

$${α}_{i j}^{r} = \frac{A t t n ( {\tilde{x}}_{i ,} {\tilde{x}}_{j} , {c}_{i} , {d}_{i j} )}{{\sum }_{k ∈ {N}_{i}^{r}} Attn ( {\tilde{x}}_{i} , {\tilde{x}}_{j} , {c}_{i} , {c}_{k} , {d}_{i k} )} \qquad formula ( 2 )$$

Where Attn represents an attention mechanism function, which may be set as needed and is used to measure spatial correlation between two monitoring stations; cᵢ, cⱼ are environmental context features (which, specifically, may include POI distribution and road network features) around the monitoring stations sᵢ, sⱼ; dᵢⱼ represents a spherical distance between two monitoring stations; Nᵢ^{r} represents a neighboring monitoring station (i.e., other monitoring station with a distance of less than a set value of 20 km in this example) with an edge connected to the monitoring site sᵢ in the graph G of heterogeneous stations.

Based on αᵢⱼ^{r}, this example may further define context-aware heterogeneous graph convolution operation, which updates a station's characterization by aggregating a neighbor monitoring station's characterization with the following formula:

\tilde{x}ᵢ^{r}′=GConv(\tilde{x}ᵢ,r)=σ(Σ_{j∈N}_{ᵢ}_{^{r}}W^{r}\tilde{x}ⱼ) formula (3)

Where \tilde{x}ᵢ^{r}′ may be a monitoring station representation based on aggregation of edge type r; a may be a nonlinear activation function; W^{r} may be a shared parameter corresponding to the type r of the same edge. In this example, by splicing all neighbor monitoring stations of the monitoring station sᵢ, a final characterization of the monitoring station sᵢ is obtained as:

\tilde{x}ᵢ′=∥_{r∈Ψ}GConv(\tilde{x}ᵢ,r) formula (4)

Where ∥ represents splicing operation. In this example, the output \tilde{x}ᵢ′ of this layer of the heterogeneous graph neural network may be used as input of the next layer, and formulas (2)-(4) can be calculated repeatedly to obtain a representation vector of the monitoring station sᵢ that encodes multi-order neighbor relationship.

Step S53: modeling temporal correlation among the monitoring stations based on a heterogeneous recurrent neural network.

In this example, a gated recurrent neural network (GRU) is used to capture temporal correlation of monitoring stations. Since time series of monitoring stations of different categories are heterogeneous, in this example, different parameters are used for monitoring stations of different categories to model with the following formulas:

oᵢ^{t}=σ(Wₒ^{φ(i)}[hᵢ^{t-1},\tilde{x}ᵢ′]+bₒ^{φ(i)}) formula (5)

zᵢ^{t}=σ(W_{z}^{φ(i)}[hᵢ^{t-1},\tilde{x}ᵢ′]+b_{z}^{φ(i)}) formula (6)

\tilde{h}ᵢ^{t}=tanh(W_{\tilde{h}}^{φ(i)}rᵢ^{t}∘hᵢ^{t-1},\tilde{x}ᵢ′]+b_{\tilde{h}}^{φ(i)}) formula (7)

hᵢ^{t}=(1−zᵢ^{t})∘hᵢ^{t-1}+zᵢ^{t}∘\tilde{h}ᵢ^{t} formula (8)

By taking the output hᵢ^{t-1} of the gated recurrent neural network at a moment t−1 and the output 5c″; of the heterogeneous graph neural network at a moment t as the input data of the model, combined with the gating mechanism, an output hᵢ^{t} at the moment t can be obtained. Wₒ^{φ(i)}, W_{z}^{φ(i)}, W_{\tilde{h}}^{φ(i)}, b₀^{φ(i)}, b_{z}^{φ(i)}, b_{\tilde{h}}^{φ(i)} are model parameters shared between monitoring stations of the same category. oᵢ^{t}, zᵢ^{t} may be intermediate variables inside the model. Since \tilde{x}ᵢ′ includes dynamic spatial correlation information between the monitoring station and all its neighbor monitoring stations at the moment t, and hᵢ^{t-1} includes temporal-and-spatial correlation information between the monitoring station and all its neighbor monitoring stations before the moment t, the obtained hᵢ^{t} also encode the past temporal-and-spatial information.

In a prediction phase of the model, in this example, another GRU is used as a decoder for performing AQI prediction and weather prediction step-by-step, and prediction values generated by the decoder is (Ŷ^{t+1}, Ŷ^{t+2}, . . . , Ŷ^{t+τ}). A series of values are output by the decoder each time for a weather parameter of the same category. For example, a first sequence output by the decoder is temperature prediction values, a second sequence output by the decoder is air quality prediction values, and so on.

Step S54: training the model.

In this example, an optimization goal of the model is to minimize mean square error (MSE) between a prediction and a true value. The objective function of the loss value may be expressed as:

$${L}_{g} = \frac{1}{τ} {\sum }_{i = 1}^{τ} {( {\hat{Y}}^{t + i} - {Y}^{t + i} )}^{2} \qquad formula ( 9 )$$

Where τ may be a preset value at time point, i.e., a predicted time step.

One embodiment of the present disclosure further provides a weather parameter prediction model training apparatus, as shown in FIG. 6, including:

an establishment module 61 configured for establishing a weather parameter prediction model according to spatial correlation information among a plurality of monitoring stations; and

an adjustment module 62 configured for adjusting the weather parameter prediction model according to observation values of a weather parameter for the plurality of monitoring stations and prediction values of the weather parameter for the plurality of monitoring stations output by the weather parameter prediction model.

In one embodiment, the plurality of monitoring stations include monitoring stations of a plurality of categories. The monitoring stations of each category are used to monitor a weather parameter of a corresponding category.

In one embodiment, the spatial correlation information among monitoring stations of the plurality of categories is determined according to spatial correlation information between each monitoring station and other monitoring station. A neighboring monitoring station of each monitoring station is one of monitoring stations of the plurality of categories, which has a neighbor relationship with the each monitoring station.

In one embodiment, the spatial correlation information among the plurality of monitoring stations includes spatial correlation information between each monitoring station and other monitoring station. The neighbor relationship between the monitoring stations is determined according to a distance between the monitoring stations.

The spatial correlation information between each monitoring station and other monitoring station is determined according to a dynamic connection line weight between each monitoring station and other monitoring station, observation data of each monitoring station and other monitoring station and categories of each monitoring station and other monitoring station.

In one embodiment, the dynamic connection line weight between each monitoring station and other monitoring station is determined according to a spherical distance between each monitoring station and other monitoring station, and environmental context features of each monitoring station and other monitoring station.

In one embodiment, the spatial correlation information among each monitoring station and other monitoring stations is determined by the following modules of the apparatus:

a projection module 71 configured for projecting observation data of each monitoring station and other monitoring station into an identical representation space to obtain projection values of each monitoring station and other monitoring station; and

a projection value processing module 72 configured for determining spatial correlation information among monitoring stations of the plurality of categories, according to the projection values of each monitoring station and other monitoring station.

In one embodiment, the spatial correlation information between each monitoring station and other monitoring station is determined according to spatial correlation information among each monitoring station and its all other monitoring stations.

In one implementation, the correlation information between each monitoring station and other monitoring station is determined according to a projection value of other monitoring station, a dynamic connection line weight between each monitoring station and other monitoring station, a category of each monitoring station and a category of every other monitoring station.

In one embodiment, as shown in FIG. 8, the correlation information between each monitoring station and other monitoring station is determined by the following modules of the weather parameter prediction model training apparatus:

a first characterization value module 81 configured for, for every other monitoring station, multiplying a dynamic connection line weight between every other monitoring station and each monitoring station, a dynamic connection line type between every other monitoring station and each monitoring station, and a projection value of every other monitoring station, to obtain a first characteristic value of every other monitoring station;

a second characterization value module 82 configured for, for every other monitoring station, performing calculation on the first characteristic value of every other monitoring station by using nonlinear activation function to obtain a second characteristic value of every other monitoring station; and

a splicing module 83 configured for, for each monitoring station, splicing the second characteristic values of all other monitoring stations to obtain the spatial correlation information among each monitoring station and other monitoring stations.

In one embodiment, the monitoring stations of the plurality of categories include a monitoring station for monitoring a weather parameter of a first category and a monitoring station for monitoring a weather parameter of a second category.

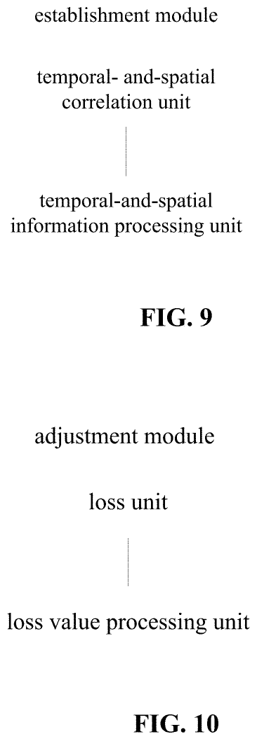

In one embodiment, as shown in FIG. 9, the establishment module includes:

a temporal-and-spatial correlation unit 91 configured for determining temporal-and-spatial correlation information among the plurality of monitoring stations according to the spatial correlation information among the plurality of monitoring stations and historical temporal-and-spatial correlation information among the plurality of monitoring stations; and

a temporal-and-spatial information processing unit 92 configured for establishing the weather parameter prediction model according to the temporal-and-spatial correlation information among the plurality of monitoring stations.

In one embodiment, the temporal-and-spatial correlation unit 91 is further configured for

performing a gate recurrent operation on the spatial correlation information among the plurality of monitoring stations and the historical temporal-and-spatial correlation information among the monitoring stations to obtain the temporal-and-spatial correlation information among the plurality of monitoring stations.

In one embodiment, as shown in FIG. 10, the adjustment module includes:

a loss unit 101 configured for calculating a loss value according to a least square error of the observation values and the prediction values;

a loss value processing unit 102 configured for adjusting the weather parameter prediction model according to the loss value.

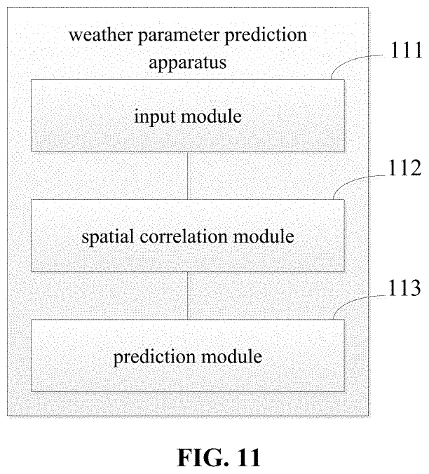

As shown in FIG. 11, one embodiment of the present disclosure further provides a weather parameter prediction apparatus, including:

an input module 111 configured for taking at least one of historical observation values and environmental context features of the plurality of monitoring stations as input data, and inputting the input data into a weather parameter prediction model; where the weather parameter prediction model is the weather parameter prediction model provided in any one of the embodiments of the present disclosure;

a spatial correlation module 112 configured for using the weather parameter prediction model to determine spatial correlation information among the plurality of monitoring stations, according to at least one of the historical observation values and environmental context features of the plurality of monitoring stations obtained from the input data; and

a prediction module 113 configured for using the weather parameter prediction model to output a weather parameter prediction value according to the spatial correlation information among the plurality of monitoring stations.

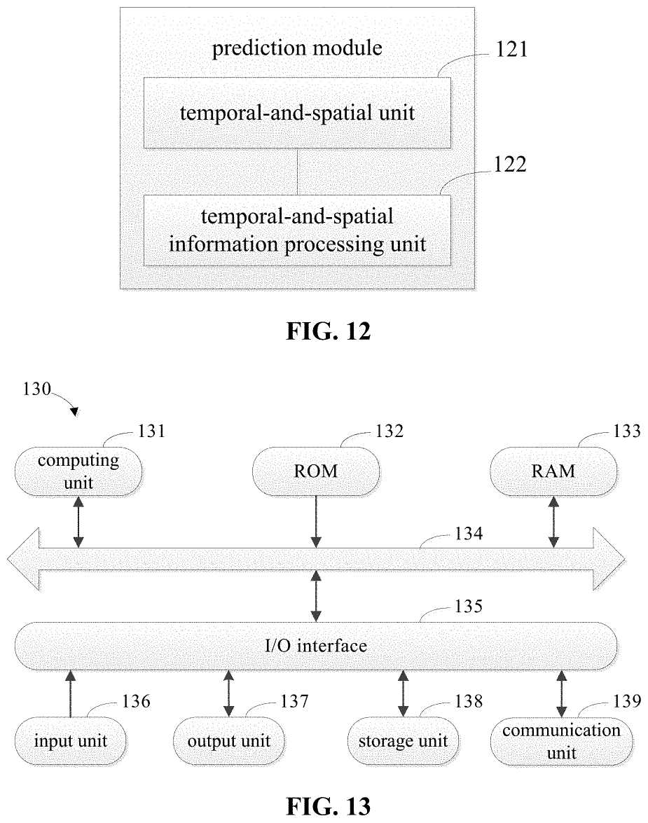

In one embodiment, as shown in FIG. 12, the prediction module includes:

a temporal-and-spatial unit 121 configured for using the weather parameter prediction model to determine temporal-and-spatial correlation information among the plurality of monitoring stations according to the spatial correlation information among the plurality of monitoring stations; and

a temporal-and-spatial information processing unit 122 configured for using the weather parameter prediction model to determine the weather parameter prediction value of the plurality of monitoring stations according to the temporal-and-spatial correlation information among the plurality of monitoring stations.

Functions of the units, modules or sub-modules in the data processing apparatus in the embodiments of the present disclosure may refer to corresponding descriptions in the foregoing data processing method, which will not be repeated here.

Various embodiments of the present disclosure may be applied to the technical fields of artificial intelligence such as deep learning and big data, and may be used for weather data processing and weather parameter prediction in areas with a plurality of administrative regions.

According to the embodiments of the present disclosure, the present disclosure further provides an electronic device, a readable storage medium, and a computer program product.

FIG. 13 is a schematic block diagram of an electronic device 130 that may be configured for implementing embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital processing, cellular telephones, smart phones, wearable devices, and other similar computing devices. The components shown herein, their connections and relationships, and their functions are by way of example only and are not intended to limit the implementations of the present disclosure described and/or claimed herein.

As shown in FIG. 13, the electronic device 130 includes a computing unit 131, which may perform various appropriate actions and processing according to a computer program stored in a Read-Only Memory (ROM) 132 or a computer program loaded from a storage unit 138 into a Random Access Memory (RAM) 133. In the RAM 133, various programs and data required for the operation of the electronic device 130 may also be stored. The computing unit 131, the ROM 132 and the RAM 133 are connected to each other through a bus 134. An input/output (I/O) interface 135 is also connected to the bus 134.

A plurality of components in the electronic device 130 are connected to the I/O interface 135, and include: an input unit 136, such as a keyboard and a mouse; an output unit 137, such as various types of displays and speakers; a storage unit 138, such as a disk, and an optical disc; and a communication unit 139, such as a network card, a modem, and a wireless communication transceiver. The communication unit 139 allows the electronic device 130 to exchange information/data with other devices through a computer network such as the Internet and/or various telecommunication networks.

The computing unit 131 may be various general-purpose and/or special-purpose processing components with processing and computing capabilities. Some examples of the computing unit 131 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, etc. The computing unit 131 performs various methods and processes described above, such as the weather parameter prediction model training method. For example, in some embodiments, the weather parameter prediction model training method may be implemented as a computer software program, which is tangibly contained in a machine-readable medium, such as the storage unit 138. In some embodiments, part or all of the computer programs may be loaded and/or installed on the electronic device 130 through the ROM 132 and/or the communication unit 139. When the computer program is loaded into the RAM 133 and executed by the computing unit 131, one or more steps of the foregoing weather parameter prediction model training method can be executed. Alternatively, in other embodiments, the computing unit 131 may be configured to perform the weather parameter prediction model training method in any other suitable means (for example, by means of firmware).

Various implementations of systems and technologies described herein above may be implemented in a digital electronic circuit system, an integrated circuit system, a field programmable gate array (FPGA), an application specific integrated Circuit (ASIC), an application specific standard product (ASSP), a system on chip (SOC), a complex programmable logic device (CPLD), computer hardware, firmware, software, and/or a combination thereof. These various implementations may include: being implemented in one or more computer programs, where the one or more computer programs may be executed and/or interpreted on a programmable system including at least one programmable processor. The programmable processor may be a special-purpose or general-purpose programmable processor, which can receive data and instructions from a storage system, at least one input device and at least one output device, and transmit the data and instructions to the storage system, the at least one input device and the at least one output device.

Program codes configured to implement the method of the present disclosure may be written in any combination of one or more programming languages. These program codes can be provided to a processor or a controller of a general-purpose computer, a special-purpose computer, or other programmable data processing apparatus, so that the program codes are executed by the processor or controller to cause functions and/or operations specified in the flowcharts and/or block diagrams to be implemented. The program codes may be executed entirely on a machine, partly executed on the machine, partly executed on the machine and partly executed on a remote machine as an independent software package, or entirely executed on the remote machine or a server.

In the context of the present disclosure, the machine-readable medium may be a tangible medium, which may contain or store a program which may be used by an instruction execution system, apparatus, or device or may be used in combination with the instruction execution system, apparatus, or device. The machine-readable medium may be a machine-readable signal medium or a machine-readable storage medium. The machine-readable medium may include but is not limited to, electronic, magnetic, optical, electromagnetic, infrared, or semiconductor system, apparatus, or device, or any suitable combination of the foregoing. Specific examples of the machine-readable storage medium include electrical connections based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

To provide for interaction with a user, the systems and techniques described herein may be implemented on a computer having: a display device (e.g., a Cathode Ray Tube (CRT) or Liquid Crystal Display (LCD) monitor) for displaying information to a user; and a keyboard and a pointing device (e.g., a mouse or a trackball) by which a user can provide input to the computer. Other types of devices may also be used to provide interaction with a user; for example, the feedback provided to the user may be any form of sensory feedback (e.g., visual feedback, audile feedback, or tactile feedback); and input from the user may be received in any form, including acoustic input, audio input, or tactile input.

The systems and techniques described herein may be implemented in a computing system that includes a background component (e.g., as a data server), or a computing system that includes a middleware component (e.g., an application server), or a computing system that includes a front-end component (e.g., a user computer having a graphical user interface or a web browser through which a user may interact with embodiments of the systems and techniques described herein), or in a computing system that includes any combination of such background component, middleware component, or front-end component. The components of the system may be interconnected by digital data communication (e.g., a communication network) of any form or medium. Examples of the communication network include: Local Area Networks (LANs), Wide Area Networks (WANs), and the Internet.

The computer system may include a client and a server. The client and the server are typically remote from each other and typically interact through a communication network. A relationship between the client and the server is generated by computer programs operating on respective computers and having a client-server relationship with each other.

It will be appreciated that the various forms of flow, reordering, adding or removing steps shown above may be used. For example, the steps recited in the present disclosure may be performed in parallel or sequentially or may be performed in a different order, so long as the desired results of the technical solutions disclosed in the present disclosure can be achieved, and no limitation is made herein.

The above-mentioned embodiments are not to be construed as limiting the scope of the present disclosure. It will be apparent to a person skilled in the art that various modifications, combinations, sub-combinations and substitutions are possible, depending on design requirements and other factors. Any modifications, equivalents, and improvements within the spirit and principles of this disclosure are intended to be included within the scope of the present disclosure.

What is claimed is:

1. A weather parameter prediction model training method, comprising:
establishing a weather parameter prediction model according to spatial correlation information among a plurality of monitoring stations; and
adjusting the weather parameter prediction model, according to observation values of a weather parameter for the plurality of monitoring stations and prediction values of the weather parameter for the plurality of monitoring stations output by the weather parameter prediction model.

2. The method of claim 1, wherein the plurality of monitoring stations comprise monitoring stations of a plurality of categories; the monitoring stations of each category are used to monitor a weather parameter of a corresponding category.

3. The method of claim 2, wherein the spatial correlation information among the plurality of monitoring stations is determined according to a dynamic connection line weight between each monitoring station and other monitoring station, observation data of each monitoring station and other monitoring station and categories of each monitoring station and other monitoring station.

4. The method of claim 3, wherein the dynamic connection line weight between each monitoring station and other monitoring station is determined according to a spherical distance between each monitoring station and other monitoring station, and environmental context features of each monitoring station and other monitoring station.

5. The method of claim 3, wherein spatial correlation information between each monitoring station and other monitoring station is determined in a way comprising:
projecting observation data of each monitoring station and other monitoring station into an identical representation space to obtain projection values of each monitoring station and other monitoring station; and
determining the spatial correlation information among monitoring stations of the plurality of categories, according to the projection values of each monitoring station and other monitoring station.

6. The method of claim 5, wherein the spatial correlation information between each monitoring station and other monitoring station is determined according to spatial correlation information among each monitoring station and its all other monitoring stations.

7. The method of claim 6, wherein the spatial correlation information between each monitoring station and other monitoring station is determined according to the projection value of other monitoring station, the dynamic connection line weight between each monitoring station and other monitoring station, the category of each monitoring station and the category of every other monitoring station.

8. The method of claim 7, wherein the spatial correlation information between each monitoring station and other monitoring station is calculated in a way comprising:
for every other monitoring station, multiplying a dynamic connection line weight between every other monitoring station and each monitoring station, a dynamic connection line type between every other monitoring station and each monitoring station, and a projection value of every other monitoring station, to obtain a first characteristic value of every other monitoring station;
for every other monitoring station, performing calculation on the first characteristic value of every other monitoring station by using nonlinear activation function to obtain a second characteristic value of every other monitoring station; and
for each monitoring station, splicing the second characteristic values of all other monitoring stations to obtain the spatial correlation information among each monitoring station and other monitoring stations.

9. The method of claim 2, wherein the monitoring stations of the plurality of categories comprise a monitoring station for monitoring a weather parameter of a first category and a monitoring station for monitoring a weather parameter of a second category.

10. The method of claim 1, wherein the establishing the weather parameter prediction model according to the spatial correlation information among the plurality of monitoring stations, comprises:
determining temporal-and-spatial correlation information among the plurality of monitoring stations according to the spatial correlation information among the plurality of monitoring stations and historical temporal-and-spatial correlation information among the plurality of monitoring stations; and
establishing the weather parameter prediction model according to the temporal-and-spatial correlation information among the plurality of monitoring stations.

11. The method of claim 10, wherein the determining the temporal-and-spatial correlation information among the plurality of monitoring stations according to the spatial correlation information among the plurality of monitoring stations and the historical temporal-and-spatial correlation information among the plurality of monitoring stations, comprises:
performing a gate recurrent operation on the spatial correlation information among the plurality of monitoring stations and the historical temporal-and-spatial correlation information among the monitoring stations to obtain the temporal-and-spatial correlation information among the plurality of monitoring stations.

12. The method of claim 1, wherein the adjusting the weather parameter prediction model according to the observation values of the weather parameter for the plurality of monitoring stations and the prediction values of the weather parameter for the plurality of monitoring stations output by the weather parameter prediction model, comprises:
calculating a loss value according to a least square error of the observation values and the prediction values; and
adjusting the weather parameter prediction model according to the loss value.

13. A weather parameter prediction method, comprising:
taking at least one of historical observation values and environmental context features of a plurality of monitoring stations as input data, and inputting the input data into a weather parameter prediction model; wherein the weather parameter prediction model is obtained in a way comprising:
establishing the weather parameter prediction model according to spatial correlation information among a plurality of monitoring stations; and adjusting the weather parameter prediction model, according to observation values of a weather parameter for the plurality of monitoring stations and prediction values of the weather parameter for the plurality of monitoring stations output by the weather parameter prediction model;
using the weather parameter prediction model to determine spatial correlation information among the plurality of monitoring stations, according to the at least one of the historical observation values and the environmental context features of the plurality of monitoring stations obtained from the input data; and
using the weather parameter prediction model to output a weather parameter prediction value according to the spatial correlation information among the plurality of monitoring stations.

14. The method of claim 13, wherein the using the weather parameter prediction model to output the weather parameter prediction value according to the spatial correlation information among the plurality of monitoring stations, comprises:
using the weather parameter prediction model to determine temporal-and-spatial correlation information among the plurality of monitoring stations according to the spatial correlation information among the plurality of monitoring stations; and
using the weather parameter prediction model to determine the weather parameter prediction value of the plurality of monitoring stations according to the temporal-and-spatial correlation information among the plurality of monitoring stations.

15. An electronic device, comprising:
at least one processor; and
a memory communicatively connected to the at least one processor; wherein,
the memory stores instructions executable by the at least one processor to enable the at least one processor to perform operations of:
establishing a weather parameter prediction model according to spatial correlation information among a plurality of monitoring stations; and
adjusting the weather parameter prediction model, according to observation values of a weather parameter for the plurality of monitoring stations and prediction values of the weather parameter for the plurality of monitoring stations output by the weather parameter prediction model.

16. The electronic device of claim 15, wherein the plurality of monitoring stations comprise monitoring stations of a plurality of categories; the monitoring stations of each category are used to monitor a weather parameter of a corresponding category.

17. An electronic device, comprising:
at least one processor; and
a memory communicatively connected to the at least one processor; wherein,
the memory stores instructions executable by the at least one processor to enable the at least one processor to perform operations of:
taking at least one of historical observation values and environmental context features of a plurality of monitoring stations as input data, and inputting the input data into a weather parameter prediction model; wherein the weather parameter prediction model is obtained in a way comprising: establishing the weather parameter prediction model according to spatial correlation information among a plurality of monitoring stations; and adjusting the weather parameter prediction model, according to observation values of a weather parameter for the plurality of monitoring stations and prediction values of the weather parameter for the plurality of monitoring stations output by the weather parameter prediction model;
using the weather parameter prediction model to determine spatial correlation information among the plurality of monitoring stations, according to the at least one of the historical observation values and the environmental context features of the plurality of monitoring stations obtained from the input data; and
using the weather parameter prediction model to output a weather parameter prediction value according to the spatial correlation information among the plurality of monitoring stations.

18. The electronic device of claim 17, wherein the using the weather parameter prediction model to output the weather parameter prediction value according to the spatial correlation information among the plurality of monitoring stations, comprises:
using the weather parameter prediction model to determine temporal-and-spatial correlation information among the plurality of monitoring stations according to the spatial correlation information among the plurality of monitoring stations; and
using the weather parameter prediction model to determine the weather parameter prediction value of the plurality of monitoring stations according to the temporal-and-spatial correlation information among the plurality of monitoring stations.

19. A non-transitory computer-readable storage medium storing computer instructions for causing the computer to perform operations of:
establishing a weather parameter prediction model according to spatial correlation information among a plurality of monitoring stations; and
adjusting the weather parameter prediction model, according to observation values of a weather parameter for the plurality of monitoring stations and prediction values of the weather parameter for the plurality of monitoring stations output by the weather parameter prediction model.

20. A non-transitory computer-readable storage medium storing computer instructions for causing the computer to perform operations of:
taking at least one of historical observation values and environmental context features of a plurality of monitoring stations as input data, and inputting the input data into a weather parameter prediction model; wherein the weather parameter prediction model is obtained in a way comprising:
establishing the weather parameter prediction model according to spatial correlation information among a plurality of monitoring stations; and adjusting the weather parameter prediction model, according to observation values of a weather parameter for the plurality of monitoring stations and prediction values of the weather parameter for the plurality of monitoring stations output by the weather parameter prediction model;
using the weather parameter prediction model to determine spatial correlation information among the plurality of monitoring stations, according to the at least one of the historical observation values and the environmental context features of the plurality of monitoring stations obtained from the input data; and
using the weather parameter prediction model to output a weather parameter prediction value according to the spatial correlation information among the plurality of monitoring stations.
